(19) United States
(12) Patent Application Publication
(10) Pub. No.: US 2026/0058887 A1
(43) Pub. Date: Feb. 26, 2026

(54) TECHNOLOGIES FOR UBIQUITOUS COMPUTING

(71) Applicant: Apple Inc., Cupertino, CA (US)

(72) Inventors: Ralf Rossbach, Munich (DE); Mona Agnel, Guildford Surrey (GB); Sudeep Manithara Vamanan, Nuremberg (DE); Walter Featherstone, Cirencester Gloucestershire (GB)

(73) Assignee: Apple Inc., Cupertino, CA (US)

(21) Appl. No.: 19/287,787

(22) Filed: Jul. 31, 2025

Related U.S. Application Data
(60) Provisional application No. 63/685,216, filed on Aug. 20, 2024.

(51) Int. Cl. H04L 41/5009; H04L 43/0882; H04W 8/22; H04W 8/26; H04W 12/06; H04W 60/04

(52) U.S. Cl. CPC H04L 41/5012; H04L 43/0882; H04W 8/22; H04W 8/265; H04W 12/06; H04W 60/04

(57) ABSTRACT

The present application relates to devices and components including apparatus, systems, and methods for ubiquitous computing.

### CROSS-REFERENCE TO RELATED APPLICATION

This application claims priority to U.S. Provisional Patent Application No. 63/685,216, filed Aug. 20, 2024, which is hereby incorporated by reference in its entirety.

### TECHNICAL FIELD

This application relates generally to communication networks and, in particular, to technologies for ubiquitous computing in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates architecture approaches in accordance with some embodiments.

FIG. 3 illustrates another network environment in accordance with some embodiments.

FIG. 4 illustrates another network environment in accordance with some embodiments.

FIG. 5 illustrates a procedure in accordance with some embodiments.

FIG. 6 illustrates another procedure in accordance with some embodiments.

FIG. 7 illustrates another network environment in accordance with some embodiments.

FIG. 8 illustrates an operational flow/algorithmic structure in accordance with some embodiments.

FIG. 9 illustrates another operational flow/algorithmic structure in accordance with some embodiments.

FIG. 10 illustrates another operational flow/algorithmic structure in accordance with some embodiments.

FIG. 11 illustrates a user equipment in accordance with some embodiments.

FIG. 12 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

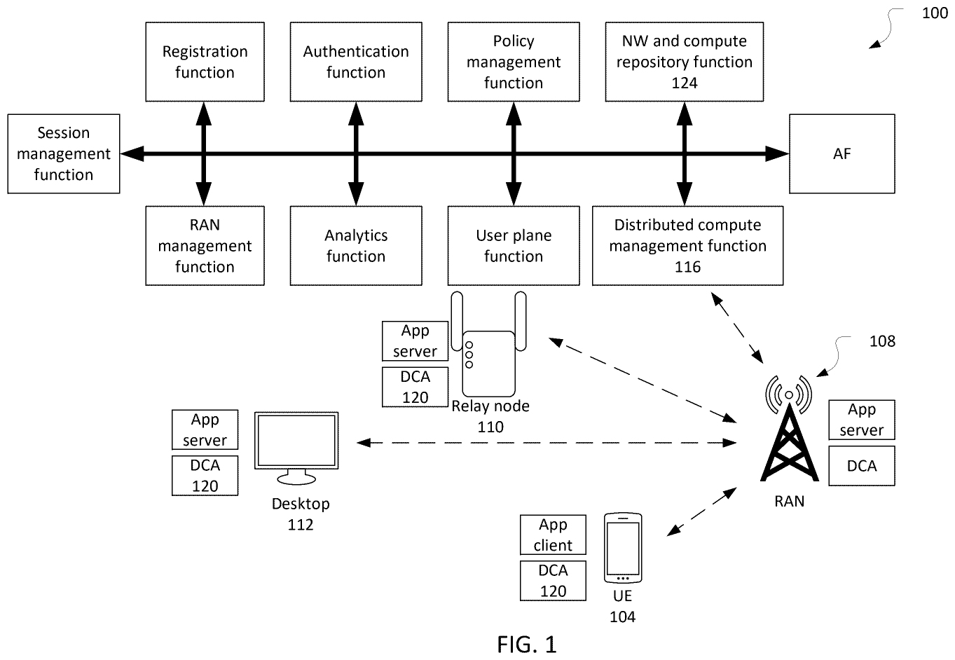

FIG. 1 illustrates a network environment 100 in accordance with some embodiments. The network environment 100 may include a user equipment (UE) 104, a relay node 110, and a desktop 112 communicatively coupled with a base station 108 of a radio access network (RAN). The UE, relay node, and desktop may communicate with the base station over air interfaces compatible with 3GPP TSs such as those that define a Sixth Generation (6G) system or a later system.

The network environment 100 may further include a core network coupled to the base station 108 via a fiber optic or wireless backhaul. The core network may provide various network functions for the devices of the network environment.

The network environment 100 may represent a 3GPP Core Network Centric Approach with an integrated compute and network fabric that provides a distributed intelligence that collects and analyzes information on communication and computation resources in a mobile wireless network, discovers desired resources/paths (e.g., communication path to a computing resource) to offload computing tasks while preserving user privacy, and helps in executing offload operations.

New network functions may include a Distributed Computing Management Function (DCMF) 116, distributed computing agents (DCAs) 120, and a network compute repository function (NCRF) 124.

The DCMF 116 may be a Network Function responsible for onboarding and provisioning network nodes with respect to computing resources and needs. The DCMF 116 may also be responsible for discovery of desired compute resource and communication paths within the framework of trust and privacy requirements from application providers and users. The DCMF 116 may interact with Application Functions (directly or through a Network Exposure framework), Session Management Function, and DCAs 120. A UE may also be considered a network node in this context.

A DCA 120 is an entity that is embedded in the network nodes providing/requesting computing resources. The DCA 120 has a server side and client side instantiation. The DCA 120 takes care of communication with the DCMF 116.

The NCRF 124 may provide some repository functions similar to a 5G Network Repository Function (NRF). The NCRF 124 may also be responsible for registering network nodes with computing resources (including computing resources provided by a 3rd party), and aiding their onboarding and discovery.

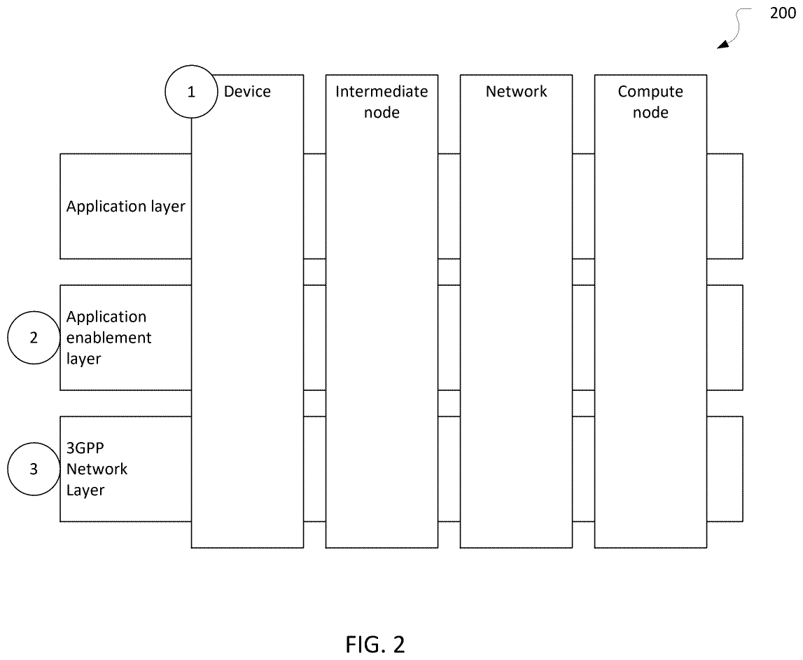

FIG. 2 illustrates architecture approaches 200 in accordance with some embodiments.

A first approach may be a device-centric approach that may be an extension or re-use of Proximity Services (ProSe) discovery or device-to-device (D2D) communications. An autonomous sub-network may use a local controller acting as a base station+device or cluster head. Thus, a local network may be maintained without a core network (CN). The compute aspects may be considered ‘application layer.’ Local devices may support local versions of Application Enablement or 3GPP network layer functions.

A second approach may be an application enablement layer, which may be independent from a network. For example, the solution may be deployed separately from an operator network. A company may deploy related servers/functions that may be used for devices associated with that company. In some instances, the compute network functions (NFs) of FIG. 1 may be understood as deployed through an application enablement or application-centric approach.

A third approach may be a 3GPP network layer approach. In this approach, functions and entities may be controlled by an operator. Key functions may reside in an operator core network.

As opposed to 5G where functions and services for computing are mostly defined as services ‘over the top’ or provided behind a 3GPP ‘border’ gateway at such as a user plane function (UPF), compute functions of 6G may become a central or integral part of the 3GPP network itself. This may be enabled by an architecture and respective network elements that form part of the 3GPP network.

Embodiments of this disclosure provide a system architecture and basic framework for ubiquitous computing from a device-centric perspective. This may be done by adding components and interactions between distributed computing network functions.

Proposed aspects are centered around the idea that a compute NF such as a DCMF or NCRF can be hosted at a local device instance, for example on a powerful device. While DCMF-DCA procedures are considered agnostic to the communication or connectivity layer, the compute functions may form a separate functional layer that is part of the 6G network itself.

Embodiments provide: additional control functions, with a view to computing being performed at the device side; options to facilitate the introduction of compute nodes capable of running NFs, such as a DCMF or NCRF, as a local NF instance at a base station or on a powerful device; trigger points for NF failover and NF transfer, including high-level procedures for local operation; and additional network elements for orchestration and event monitoring.

Further, when a device-centric architecture uses a local DCMF/NCRF rather than a central one, some of the main differences may include that the core network's central DCMF and NCRF entities are ‘always on’ and ‘always available’, while a local DCMF/local NCRF are on devices that may move (and lose cell coverage) or may be switched off. Thus, embodiments describe how devices searching for compute resources can manage if a local DCMF/local NCRF disappears; how another local device take the L-DCMF/L-NCRF role; and how the new L-DCMF/L-NCRF role is initiated between devices.

A first aspect of this disclosure relates to compute NF (e.g., DCMF/NCRF, DCEMF, or Distributed Computing Orchestration Function (DCOF)) mode switching. While many of the embodiments herein describe DCMF/NCRF switching, it will be understood that switching of other compute NFs (e.g., DCEMF or DCOF) may be performed in similar manners.

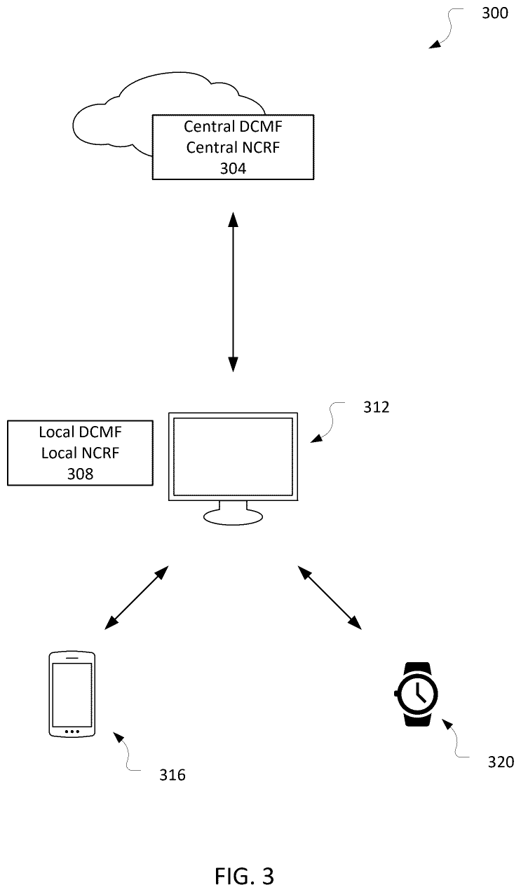

DMCF/NCRF and other compute NFs can be hosted at different locations in the network or at different cloud levels (tiers). Consider, for example, network environment 300 depicted in FIG. 3 in accordance with some embodiments. The network environment 300 may include a central DCMF/central NCRF 304 disposed on a server as part of a core network, for example, and may additionally/alternatively include a local DCMF/local NCRF 308 disposed on a local device 312, which may provide service to one or more additional local devices, for example, UEs 316 and 320.

In addition to having various central/local DCMF/NCRF, multiple DCMF/NCRF instances may work in parallel to facilitate load balancing and scaling in order to achieve the desired compute QoS according to service level agreements (SLAs). It may be noted that the DCMF/NCRF may operate as a NF, a NF Service, or a subset thereof (such as a microservice implementing part of a NF service) or a superset thereof (such as a group of NFs, NF Services or microservices).

A DCMF, NCRF or a set of DCMF/NCRF NFs may operate in one or multiple modes as indicated below. The modes may be pre-programmed (e.g., for an NF instance installed/deployed at a particular machine) or an “orchestrator” function may switch between them.

A first mode may be a centralized mode with a node (DCMF or NCRF) in the central cloud. See, for example, central DCMF/central NCRF 304 of FIG. 3. This may further include different levels of cloud tiers, some of which are closer to the user.

A second mode may be an edge mode with either a) DCMF and an NCRF in edge deployment; or b) a hybrid DCMF/NCRF (as a combined NF) in the edge cloud.

A third mode may be a local mode where an NF is hosted at a powerful device, using either a) separate local versions of DCMF and NCRF; or b) a hybrid node (of a combined DCMF/NCRF). See, for example, local DCMF/local NCRF 308 of FIG. 3.

A fourth mode may be a distributed mode where a) the DCMF or NCRF is deployed as multiple parallel NF instances (on the same tier or in different tiers), e.g., for scaling purposes; or b) some DCMF/NCRF services (or APIs) terminate at different endpoints in the 6G system.

As an alternative option when an orchestrator function is not used, the switchover between NF modes may be controlled by APIs between, e.g., central and local DCMF/NCRF. APIs can be defined to allow selectively migration of contexts of eligible subscribers or devices, depending on network or operator controlled criteria (context by context, groups of contexts/devices, etc.).

Furthermore, a DCMF may have an ‘Area Scope’ to describe the geographical range and/or number of devices associated with the node. For example, a DCMF may handle many devices in centralized mode and just very few devices in local mode.

In some embodiments, a DCMF/NCRF may have a parameter (e.g. as a capability of the node) to indicate how many device contexts it can handle.

Different DCMFs may be active at same time for different types of transactions/offloading tasks.

Some triggers and events for DCMF/NCRF mode switching are described as follows.

A network node (for example, a base station, an access point, a core NF, or a device) may have been deployed with a local copy of the DCMF/NCRF (e.g., as an image/code), and it may activate it only when needed. The NF image/code may be invoked and activated upon a trigger.

A failover event or another activation trigger may be an event that activates a switch from a central to a local DCMF/NCRF instance, or more generally, from one DCMF/NCRF instance to another DCMF/NCRF instance. Such a switch may impact existing DCMF/NCRF instance users (connections), or only be applicable to new users.

In some embodiments, the detection of a trigger can be a result of compute load measurements and network quality supervision.

Some events and measurements may be as follows.

A DCMF, NCRF (or a separate NF) may have an integrated supervision/event monitoring function or sub-function. This function creates measurement configurations, provides them to other NFs or devices, processes events & measurement results reported by NFs or devices, and notifies other NFs or devices of events or even alarms. NFs or devices can subscribe to events and get notified.

Such a supervision and event monitoring function may be integrated at different levels of the system. For example, it may be implemented as an NF or NF Service that can be deployed in a standalone manner; as part of an orchestrator, a centralized failure analytics and operations control function; as a sub-function of the DCMF or NCRF; as an extension of the 6G equivalent of the 5G NEF (monitoring events for compute NFs); in a sidecar as part of a service mesh; or as a microservice.

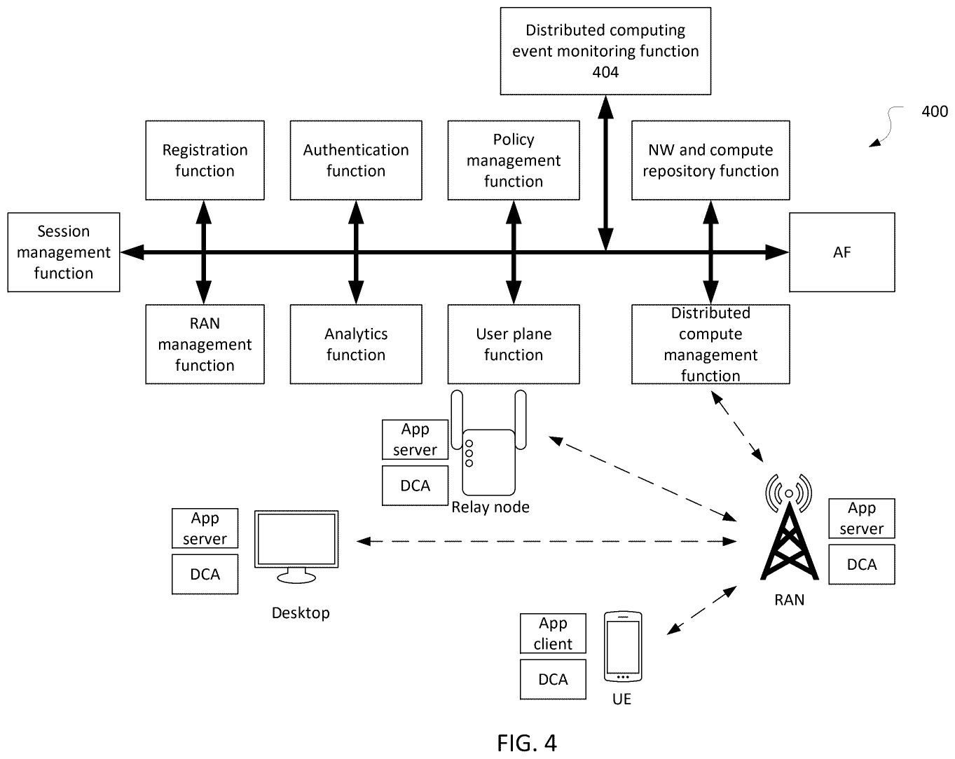

FIG. 4 illustrates a network environment 400 in accordance with some embodiments. The network environment 400 may be similar to network environment 100, except that it also includes a Distributed Computing Event Monitoring Function (DCEMF) 404 to handle supervision and event monitoring functions.

Example main functions of the DCEMF 404 include: configuration, event monitoring, calculation and reporting of key performance indicators (KPIs), failure detection, and related parameters; compute load and quality supervision measurements; event notifications (e.g., failures or statistics); collection of compute performance data and statistics; or collection and calculation of runtime metrics (e.g., in a sidecar of a service mesh).

As a side note on some of the options above: it may be implied that the role of the DCEMF 404 could be fulfilled by direct or indirect API or Proxy communication between distributed compute (DC) entities, for example, when deployed as an sub-function (or integrated component) of an NF.

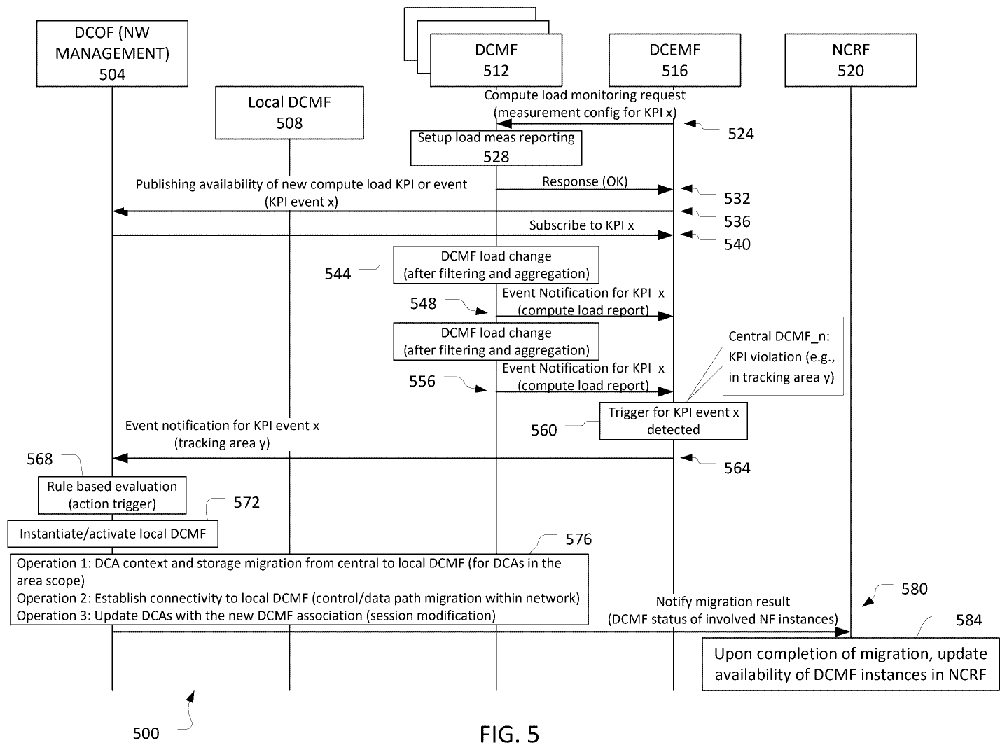

FIG. 5 illustrates a procedure 500 in accordance with some embodiments. The procedure 500 may correspond to a compute monitoring event trigger with DCMF mode switch. The procedure 500 may include signals between, and operations performed by, a DCOF 504, local DCMF 508, a central DCMF 512, DCEMF 516, and NCRF 520.

The procedure 500 may include, at 524, the DCEMF 516 generating/sending a compute load monitoring request to the central DCMF 512. The compute load monitoring request may include a measurement configuration for a KPI, for example, KPI x.

The procedure 500 may further include, at 528, the central DCMF 512 setting up load measurement reporting based on the compute load monitoring request. The central DCMF 512 may, at 532, also generate/send a response to the DCEMF 516 to confirm the load measurement reporting has been set up.

The procedure 500 may further include, at 536, the DCEMF 516 generating/sending a message to the DCOF 504. The message may publish availability of a new compute load KPI or event (for example, KPI x).

The procedure 500 may further include, at 540, the DCOF 504 generating/sending a message to the DCEMF 516 to subscribe to the new compute load KPI or event (for example, KPI x).

The procedure 500 may further include, at 544, the DCMF 512 monitoring for a load change after filtering and aggregation of compute events. At 548, the DCMF 512 may generate/send an event notification for KPI x with a compute load report to the DCEMF 516. The DCMF load change/event notification may be repeated one or more times including, for example, at 552 and 556.

The procedure 500 may further include, at 560, the DCEMF 516 detecting a trigger for KPI x. The trigger may be detected based on event notifications received from the DCMF 512. The trigger may indicate a KPI violation with respect to a particular central DCMF 512 (for example, DCMF_n) in a particular tracking area (for example, tracking area y).

The procedure 500 may further include, at 564, the DCEMF 516 sending an event notification for KPI x, with an indication of the tracking area y. When the DCEMF 516 is deployed in the orchestration layer (for example, as a subfunction of the DCOF 504), the call flow may be simplified given that external transactions between the DCEMF 516 and the DCOF 504 may no longer be needed.

The procedure 500 may further include, at 568, the DCOF 504 performing a rule-based evaluation of the event notification. This may be done to determine whether an action is triggered. Some triggers and events for DCMF/NCRF mode switching that may be relevant to procedure 500 are further described as follows. In particular, example failover events suitable to trigger a switch of DCMF/NCRF mode (e.g., the DCEMF may detect/generate them) may be one or more of the following: a) detection of a higher (or lower) frequency of distributed computing requests from DCAs; including detection of compute offloading activity after a longer period of no activity, e.g., in a geographical area, to/from/within a subnetwork of devices, or for specific types of compute requests or devices; b) Loss of backhaul connectivity; c) load balancing: up/down-scaling requests for enabling additional or fewer DCMF instances; d) QoS degradation on communication links (e.g., congestion, latency, reliability, etc.); e) compute load is greater than a threshold; f) network management decision or policy; g) OAM (manual operator intervention or operator config); h) user interaction, e.g., a startup command at a DCA, e.g., user opens an App which searches for nearby compute devices, or the App can also request a registration; i) computation response time exceeds a threshold (i.e., processing time compute the result); j) Failure of a node in the hosting cloud; k) invoking of a “Node Switch API”; l) circuit breaker (e.g., a node detecting an abnormal event (such as a timer expiry) and initiating a related procedure).

With respect to the circuit breaker event, related procedure example may be follows. The NCRF may change the DMCF node's status (in the NCRF) from active to suspended if a supervisor has received no “pulse” or “keep alive” for a specified time. Thereafter, the NCRF may re-check the DCMF's actual status at certain intervals, or based upon another event. A circuit breaker can also run in an intermediary node (such as a proxy) which supervises API calls. When the circuit breaker trips (e.g., after the number of consecutive failures crosses a threshold) then for the duration of a timeout period all attempts to invoke the remote service will fail immediately. An example may be exposure of an alarm via a service mesh, which marks a component (served by the service mesh's proxy—say, a DCMF instance) as temporarily unavailable, e.g., after a timeout or an error. It may be noted that if a DCMF is set to ‘suspended’ state it may still perform measurements and/or reporting.

If an action is triggered at 568, the procedure 500 may advance to the DCOF 504 initiating/activating the local DCMF 508 at 572.

After instantiating/activating the local DCMF 508, the DCOF 504, local DCMF 508, and the DCMF 512 may cooperate to provide one or more operations at 576 to effectuate the migration. A first operation may include the DCA contexts and storage migration from the central DCMF 512 to the local DCMF 508. This may be done for DCAs within an area scope. A second operation may include establishing connectivity to the local DCMF 508. This may include migrating control/data paths within the network. A third operation may include updating DCAs with the new DCMF association. This may be done using session modification procedures.

Upon completing the one or more operations at 576, the procedure 500 may further include the DCOF 504 generating/sending a notify migration result message to the NCRF 520 at 580. The notify migration result message may include a DCMF status of involved NF instances. It may be assumed that the local DCMF 508 is already registered with the NCRF 520. In this case, the final notify message may only be used to update the DCMF state recorded in the NCRF 520.

The procedure 500 may further include, at 584, the NCRF 520 updating the availability of DCMF instances upon completion of the migration.

DCA and DCMF measurements may be described as follows.

In addition to failure detection and monitoring of compute management tasks in the DCMFs, the DCEMF may assist the 6G CN and/or the DCMF with suitable measurements configurations of the compute workload processing in the DCA itself. The DCA's compute measurement results can be configured to be provided: directly to the DCMF (e.g., to optimize execution times and offloading/match decisions in the DCMF based on KPIs and metrics); or to the DCEMF (e.g., to supervise and control the performance of the match process and/or interact with the orchestration function), whereby the DCEMF may do post-processing and filtering of the results.

In another embodiment the DCEMF may be deployed as a sub-component of the DCMF or co-located with the DCMF.

Alternatively or additionally, the DCMF can be configured to measure compute related performance KPIs.

A measurement configuration (e.g., for monitoring event reporting) may be provided in accordance with one or more of the following options.

In a first option, the DCMF is provided with a measurement configuration.

In a second option, the DCA is provided with a measurement configuration.

In a third option, both the DCA and the DCMF are provided with a measurement configuration. The configuration can be such that event reports (of DCA and DCMF) can be deemed to be treated separately or combined. In a first suboption of the third option, one or multiple DCAs may be configured to report event monitoring results to the DCMF, and the DCMF is configured to collect and consolidate results from the DCA(s) and report them (e.g., in coarse granularity or after a configured post-processing or filtering method) to the DCEMF. Nevertheless, the monitoring results reported by the DCA(s) may still trigger immediate actions in the DCMF, regardless of the further reporting to the DCEMF. The DCA's compute measurement results may further refer to (or infer) what the DCMF would be reporting. In a second suboption of the third option, both the DCA and the DCMF are configured with independent reporting events and the consolidation of results happens in another entity (such as the DCEMF, or indirectly in the DCOF).

A second aspect of this disclosure relates to Normal/Local Operation Mode Cases.

Some embodiments relate to compute NF modes and switching. Apart from (or in addition to) the DCMF and NCRF being hosted in a central cloud, a local (and presumably hybrid) version of a DCMF/NCRF can be hosted at either a base station or a powerful device. Depending on the scenario, a local DCMF/NCRF may operate slightly differently than a central DCMF/NCRF (in terms of interfaces, number of subscribers, scaling, measurement and event reporting). It may be assumed that the 6G system includes protocols and procedures not only for communication but also for computing, storage, sensing, and AI/ML. Related communication and computing is described in further detail herein.

Normal operation for case 1 (Local Mode/Edge Mode) may be described as follows. The communication layer of the base station functions normally. Following a trigger, the local DCMF/NCRF (e.g., the computing control plane) can be hosted at or migrated to a base station or a device. The DCMF/NCRF migrates from the CN (central cloud) to the base station (edge cloud), for example, following a trigger event or due to a failure. Alternatively, a local DCMF/NCRF instance is activated at a powerful device. The central DCMA instance may be running in the background. A set of UE/DCA contexts can be associated with each local instance. Communication between local DCMF/NCRF and DCA(s) happens over the air interface. Dynamic placement of an NF from the central cloud to the edge cloud may occur, e.g., for load balancing or direct local service to DCAs. It might be a common case that is used frequently.

Failover Operation for cases 2-5 may be described as follows.

In case 2, the base station (hosting a DCMF) is unavailable for compute services. One or multiple devices are available to take over the compute control from the base station. The devices are powerful enough to offer computing services to other devices. Alternatively, a SL relay is available for the same task. Since the communication service is available the DCMF/NCRF migrates from the CN (or from the base station) to that powerful device or relay. Communication between DCMF/NCRF and DCA(s) may happen over the air interface (optionally with the base station as a relay), via sidelink (SL), or through non-3GPP access. Alternatively, the local DCMF/NCRF instance (at the base station) migrates back to the central cloud.

In case 3, the base station is unavailable for end-to-end (E2E) communication services (e.g., backhaul loss) but compute services can be provided locally. This may be done in accordance with one or more of the following two options. In a first option, a neighboring cell (or another edge server) takes over, and UE/DCA contexts are all migrated to that node. It may be assumed that the cell coverage, capacity and compute power of the neighboring cell is sufficient to take on the extra load. In this case, there is no problem. In a second option, a neighboring cell (or another edge server) is not available A local DCMF/NCRF is hosted at the base station. Communication between the local DCMF/NCRF and the DCA(s) happens over SL or over non-3GPP. Otherwise, this case is similar to case 1 and case 5 (discussed below).

In case 4, the base station is unavailable for both communication and compute, and a neighboring node is not available for migration. Both communication and computing services are transferred to a powerful device or a relay, which assumes the role of a local base station. If the powerful device can offer a normal 3GPP air interface (e.g., to act as a DU in an isolated operation for public safety (IOPS)-like mode), communication between DCMF/NCRF and DCA(s) goes via the 3GPP air interface, otherwise it goes via SL or non-3GPP access.

In case 5, an IOPS-like operation may be performed. The base station loses connection with the CN (backhaul loss) but both communication and compute can be provided as a localized service via a predefined isolated PLMN-Id.

Some local operation modes for the second aspect are described as follows.

The previous cases can be summarized as Case A: Local DCMF/NCRF hosted at the base station; and Case B: Local DCMF/NCRF hosted at a powerful device or relay.

Case A, local DCMF/NCRF hosted at the base station, may be close to normal edge computing and may be partly covered by existing procedures already. It may be assumed that the local DCMF/NCRF is pre-installed on the base station, but the service is dormant/inactive. The following triggers that allow a local DCMF/NCRF to become active include: an incoming request from a DCA that cannot be answered or served by the central/current DCMF (for multiple reasons), as described elsewhere herein; and a failover event, load balancing, etc., for example, in accordance with the first aspect. It may be noted that the DCA may be configured with a L-DCMF as backup (to another L-DCMF, or even the central DCMF) and is always aware of the central DCMF in case a local DCMF is not available.

Case B, local DCMF/NCRF hosted at a powerful device, may be described as follows. Devices indicate whether they are capable to operate as a management node (for hosting the DCMF/NCRF). One device may be allocated, pre-configured or elected to host the DCMF/NCRF. Based on the processing capabilities and availability of components indicated by devices, the DCMF configures devices accordingly. All devices form a mesh network using established SL channels or through non-3GPP access technology. A node (especially a local DCMF/NCRF) may have multiple SL connections to different UEs, or multiple RBs. Or it may act as a relay node.

Compute NF switching, for both Case A and Case B, may be described as follows.

During registration, devices register their capabilities in the CN, for example, in a NF such as the NCRF or DCMF or UDM (including their available compute power, whether they can host a DCMF, etc.).

How to configure/provision DCAs with an alternative DCMF/NCRF is described as follows. Depending on the area scope of the DCMF one or more of the following three options may be used.

In a first option, a network management entity informs all base stations of the location of the newly selected DCMF/NCRF. This may be done through a relocation message, for example. This is a broadcast to all base stations in the area scope of the DCMF/NCRF. The base station(s) provide(s) that information to all DCAs in the cell (for example, through system information). The devices may get the new DCMF in a broadcast message, which can be partially encrypted, or DCAs may be contacted by the core network directly (via NAS).

In a second option, DCAs can be provided with a secondary DCMF/NCRF (or a list of alternative DCMFs/NCRFs) during registration, that is, upfront. Then if the current DCMF/NCRF is not reachable the DCA contacts the next DCMA/NCRF in the list, and attempts to registers itself there. This can be an iterative process until registration with a new DCMF/NCRF is successful (running down the list). This may work even in a local setup without full network connection

In a third option, if all else fails the network can page the UE and provide the new DCMF/NCRF address over NAS. This may need a network connection.

The new DCMF/NCRF gets the latest config from, for example, a shared database or through pre-configuration.

A third aspect may relate to high level procedures for local DCMF/NCRF.

The framework and initial assumptions may be as follows.

Maintenance of DCMF status and administration may be performed. The NCRF has the latest information on status, location and service area of a DCMF. A DCMF may be organized as one or multiple single NFs, as one or multiple NFs with each including a set of NFs or NF Service(s) or a subset thereof (such as a microservice implementing part of a NF service) or a superset thereof (such as a group of NFs, NF Services or microservices). In either case, a DCMF registered as a local DCMF forms a single network element. In addition, the core network's communication with an NF or an NF instance that includes a set of DCMFs may optionally happen via one or more service communication proxies (SCPs). In case the DCOF is meant to be aware of the detailed DCMF subset/superset (e.g., during onboarding/instantiation) the above information may be logged at the NCRF.

Configuration may be conducted as follows. If the DCMF registration is from a UE (on a powerful device) the NCRF (or an SCP) may need an indication that this DCMF instance is running on a device that is mobile. This enables the CN (and/or the RAN) to identify that it has to page the UE in case of a remote service discovery request. Further, the DCOF may require such information as well (e.g., in order to properly dimension scaling). Alternatively, the UE hosting the NCRF and its surrounding UEs in the cluster of devices served by that local DCMF are provided with the address of the local NCRF via NAS (for example, for service recovery, so a UE always has that address as a backup).

Quality supervision may be ensured. Events and measurements to be reported to an entity, e.g. network management (see the first aspect).

The base station (or another NF) may instantiate a local DCMF/NCRF using NF/NF transfer as follows. Given that 6G is meant to support service-based interfaces in at least the control plane, the base station (for example, the CU) connected to the service bus can directly contact the central DCMF/NCRF and request UE/DCA contexts and storage data of compute nodes to be migrated. Alternatively, when a point-to-point (P2P) interface is used to connect RAN and CN a similar procedure can be introduced over the 6G N2 interface. Information can be forwarded in a transparent container between the nodes following a migration request over an API.

Local DCMF registration, migration, and activation for the third aspect may be as follows.

Under normal service conditions, a NF (for example, a DCA or an AF) calls a discovery service of an NCRF interface (for example, Nncrf_NFDiscovery Service) in the central NCRF to discover a suitable DCMF. However, if the central NCRF is unavailable or unresponsive, a UE provisioned with a second NF option can contact an alternative NCRF/DCMF (this can be a central or a local node). The UE can be provided with the server address (of the local or alternative DCMF/NCRF) beforehand, when the network service is still there. This may be done over NAS, or be pre-configured in the UE, or provided via the application layer. Alternatively or additionally, a DCA may interact with a configuration server (or alternatively a DCOF) directly, which may host similar DCMF/NCRF address information and the availability/state thereof.

One or more of the following procedures may be conducted.

In a first procedure, a device intending to provide a L-NCRF/L-DCMF, registers the local NF with the central NCRF via an AF (e.g., over NAS)

In a second procedure, other devices (e.g., the DCAs) are provided with the local DCMF/NCRF (the server address (e.g., IP address)) during NAS registration or in a separate NAS procedure. Alternatively, the server address may be pre-configured or provided via application layer signaling.

In a third procedure, once the local DCMF/NCRF is registered as a NF hosted by a UE and associated with an IP address (which happens before the NF mode switch), the CN can use normal NF/NF Service Context Transfer Procedures to transfer the service context from the cloud service instance to the UE service instance. After NF migration (e.g., from central to local) and following the NF/NF Service Context Transfer Procedure, the DCAs are notified of the new DCMF/NCRF location to use

In a fourth procedure, if the connection to the central NCRF/DCMF is unreliable, the UE knows how to connect to the local NCRF/DCMF (through implementation or configuration).

Subsequent procedures may apply to boot up (activate) the local DCMF/NCRF.

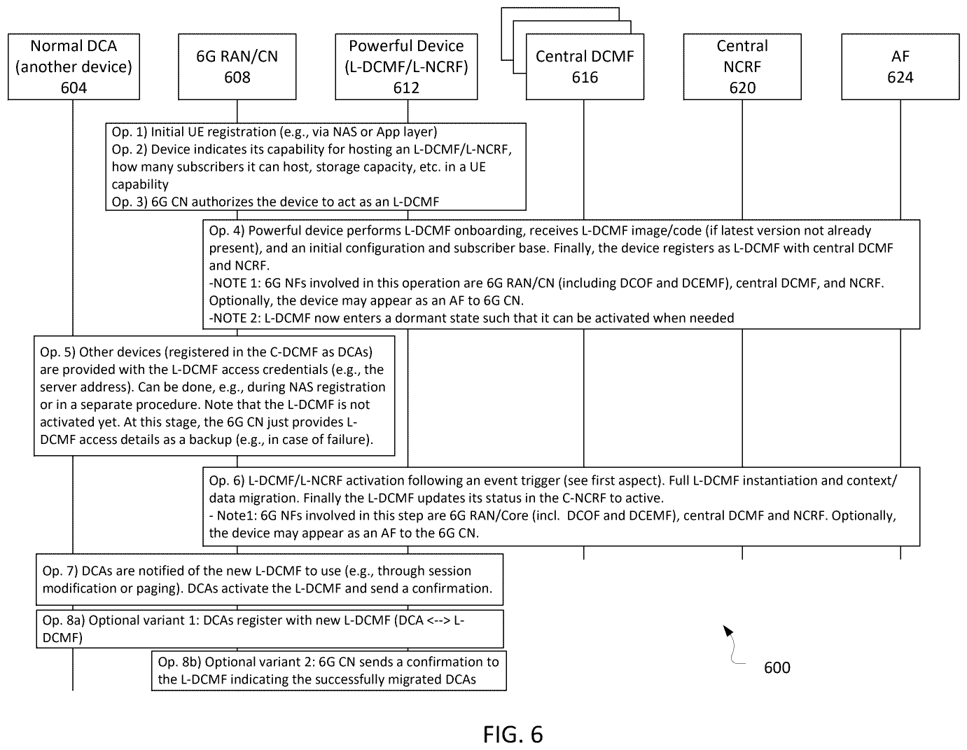

FIG. 6 illustrates a procedure 600 in accordance with some embodiments. The procedure 600 may provide local DCMF onboarding, migration, and activation from device perspective—under normal conditions with 6G CN availability. The procedure 600 may involve signals between, and operations performed by, a normal DCA 604, a 6G RAN/CN 608, a powerful device 612 such as a L-DCMF or an L-NCRF, a central DCMF 616, a central NCRF 620, and an AF 624.

In Op. 1, the powerful device 612 performs an initial UE registration with the 6G RAN/CN 608. The initial UE registration may be performed via NAS or an application (App) layer.

In operation (Op.) 2, the powerful device 612 indicates its ability to host a local DCMF and/or a local NCRF to the 6G RAN/CN 608 in a capability report. The capability report may include an indication of how many subscribers the powerful device 612 can host, storage capacity, and other UE capabilities. The 6G RAN/CN 608 may receive these indications from a number of different devices.

In Op. 3, the 6G RAN/CN 608 identifies and authorizes one or more devices, including the powerful device 612, allowed to host an L-DCMF/NCRF.

In Op. 4, the powerful device 612 performs L-DCMF onboarding and receives L-DCMF/NCRF image/application code deployed from the 6G RAN/CN 608). Alternatively, it is possible the image/code is already present in the powerful device 612 (pre-installed by the operator or it was already downloaded earlier). In the latter case the 6G RAN/CN 608 and the powerful device 612 may perform a handshake with a version check/update (if needed). The powerful device 612 verifies the image/code and may, optionally, boot up the local DCMF/NCRF for some sanity test. The powerful device 612 may also receive an initial configuration and subscriber base. The powerful device 612 may also register as a L-DCMF with the central DCMF 616 and the central NCRF 620. In some embodiments, the powerful device 612 may appear as an AF to the 6G CN. The powerful device 612 may deactivate the local DCMF/NCRF and put it in a dormant state (ready to be activated on demand).

In Op. 5, the 6G RAN/CN 608 keeps the status of hypertext transfer protocol (HTTP) resources and devices associated with the local DCMF up to date. This may involve updates to a central or local database, depending on the deployment. For example, the other devices that are registered in the C-DCMF as DCAs may be provided with the L-DCMF access credentials such as, for example, the server address. This may be done during a NAS registration or in a separate procedure. The L-DCMF may not be activated at this time. Rather, the 6G RAN/CN 608 may simply provide the L-DCMF access details as a backup, for example, in case of failure.

In Op. 6, L-DCMF/L-NCRF activation may follow an event trigger. For example, the powerful device 612 may boot up the L-DCMF/L-NCRF upon detecting the event trigger. This may be based on event monitoring and network management. The powerful device 612 may update the database and retrieve the latest of all devices and resources associated with the L-DCMF/L-NCRF. In some embodiments, DCAs are notified of a new L-DCMF/L-NCRF to use using session modification, paging, or broadcast messages. Upon activating the L-DCMF/L-NCRF, the powerful device 612 may confirm it to the 6G RAN/CN 608 and update its status as L-DCMF/L-NCRF in the central DCMF 616 or central NCRF 620 as active. The 6G NFs involved in this operation may include the 6G RAN/CN 608 (including, for example, a DCOF and DCEMF), the central DCMF 616, and the central NCRF 620. In some embodiments, the powerful device 612 may appear as an AF to the 6G CN.

In Op 7., the powerful device 612, operating as L-DCMF, or the 6G RAN/CN 608 publishes the L-DCMF/L-NCRF to its respective DCA UEs to notify the DCAs of the new L-DCMF to use. This may be done as a 6G CN or L-DCMF higher layer broadcast, via System Information from the base station(s), session modification or paging, or through a dedicated higher layer procedure from the L-DCMF or the 6G CN—to all DCAs in the area scope of the L-DCMF. The DCAs may activate the L-DCMF and send a confirmation.

In some embodiments, Op. 8 may include DCAs registering with the L-DCMF. In other embodiments, Op. 8 may include the 6G CN sending a confirmation to the L-DCMF to indicate the successfully migrated DCAs. This may be done by modifying the session.

A fourth aspect of the present disclosure relates to conditional actions.

Event monitoring for conditional actions may occur as follows. The 6G system may host more than one DCMF. Moreover, as shown in the first aspect, the 6G computing system may employ a DCEMF for a quality supervision and event monitoring. Using the DCEMF, the network would be able to configure measurements to DCAs and/or DCMFs and enable event monitoring on compute workloads. DCAs and/or DCMFs run measurements and monitor certain events to identify a performance degradation in a consistent manner.

Event monitoring can be used to provide a DCA or a DCMF/NCRF with a set of conditions to trigger the initiation of a pre-configured activity, which the UE or DCMF can initiate/perform on its own (without further network intervention). For example, assuming a DCA has been provided with access credentials (e.g., the server address) of one or multiple L-DCMFs (as on previous pages) or some other representation of one or multiple candidate alternative DCMFs, the DCA may attempt to register with an alternative DCMF under certain conditions. This is especially useful to UEs in mobility where a local DCMF may be on a device and could suddenly disappear. It is also useful in case of a system outage.

Other advantages may include signaling reduction, working in harsh radio conditions, and helping mitigate system failures.

Conditional DCMF reselection of the fourth aspect may be described as follows.

Conditional DCA registration on an alternative DCMF/NCRF may occur in some instances. The DCA may be configured with a set of measurement events, conditions, and pre-configured actions (to be executed upon matching the event condition). The framework may include one or more the following operations.

In a first operation, the DCA is provided with a condition in the form of a specific set of events to occur. This may encompass, for example, a measurement interval (to detect how frequent does the event occur) or measurement quantities such as a ‘general DCMF response time’ or the ‘time taken for allocating a workload/offloading a task’.

In a second operation, the DCA is provided with a tentative action, for example, to register with an alternative DCMF. For this reason the DCA may be provided with a priority list of one or more alternative DCMFs. The DCA may also rely on L-DCMF access credentials (for example, the server address) configured earlier, which could be referenced in the pre-configured action.

In a third operation, the DCA monitors events and collects results.

In a fourth operation, if the condition is met, the DCA executes the action pre-configured at the second operation.

The mechanism can be also used for devices to autonomously switch to local DCMF, in case the central DCMF has extremely long response times, goes out of service, or is no longer reachable.

It may be noted that in order to decouple longer DCMF response times caused by a bad communication link, the condition may include a minimum radio link quality metric as a parameter in the condition, potentially along with other radio related conditions and exceptions. Thus in a situation where the radio link is bad but the UE would anyway execute a handover, the condition is not fulfilled.

Conditional DCMF activation of the fourth aspect may be described as follows.

In some instances, conditional activation of an alternative DCMF/NCRF may occur. An alternative DCMF (such as a L-DCMF) may start autonomously when certain failure events occur. The general framework may be the same as for the conditional DCA registration described above. For example, a powerful device may activate a L-DMCF autonomously upon detecting a failure condition. They may be noted that this requires that the local DCMF image is already present and validated on the device. If DCAs activate a local DCMF or NF autonomously and there is no connection to the network (for example, activation happens as part of a failover procedure following an incident in the network), the network may not know a switchover has happened (think about backhaul loss). To mitigate this issue the L-DCMF may attempt to register with the central NCRF using alternative connectivity (non-3GPP access, SL, non-terrestrial network (NTN), etc.).

A fifth aspect of the disclosure may relate to DCMF scaling, selection and re-selection.

With multiple DCMF/NCRF nodes is the system, a network function for inter-node selection and re-selection may be desired. A computing “orchestrator” function may handle such a task. The “orchestrator” allocates alternative DCMFs and scales them up or down in accordance with load supervision and failure events.

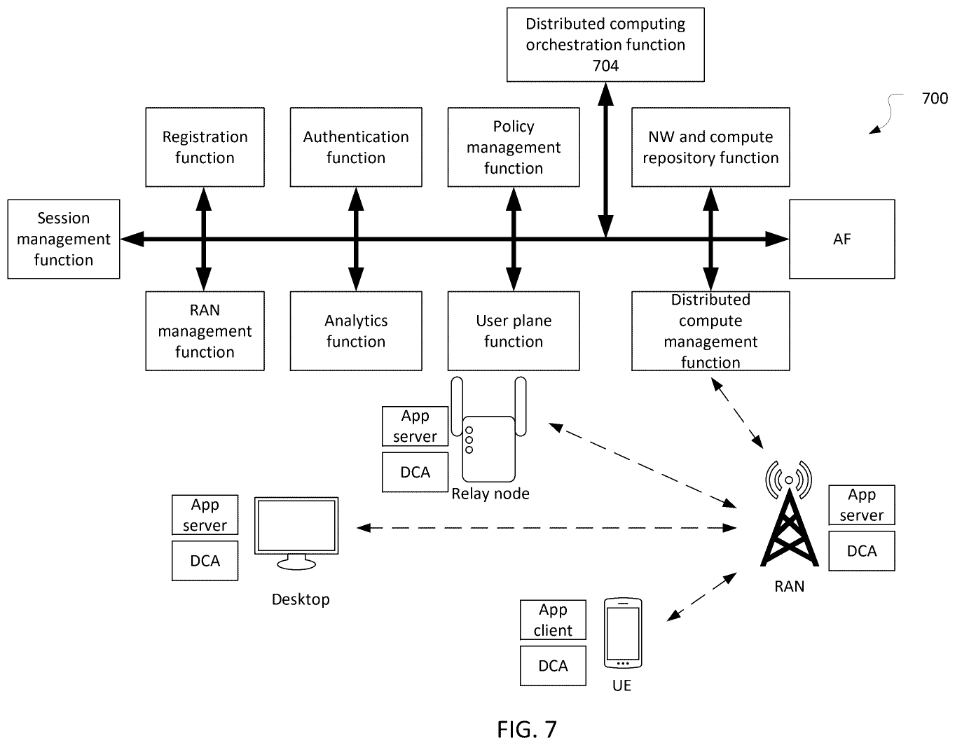

FIG. 7 illustrates another network environment 700 in accordance with some embodiments. The network environment 700 may be similar to network environment 100, except that it also includes a Distributed Computing Orchestration Function (DOCF) 704 in accordance with some embodiments. The DOCF 704 may be a new network function that acts as a dedicated entity for management of compute orchestration. The DCOF 704 may interact with AFs (direct or through Network Exposure framework), Session Management Function, DCAs (e.g., DCAserver), and NCRF.

The DCOF 704 may be integrated at different levels of the system, for example, as an NF or NF Service that can be deployed in a standalone manner; as an extension to the 6G equivalent of the 5G SCP; as a sub-function of the DCMF or NCRF; or as a microservice.

As a side note on some of the options above, it may also be implied that the role of the DCOF 704 could be fulfilled by direct or indirect API or Proxy communication between DC entities, for example, when deployed as an sub-function (or integrated component) of an NF.

A sixth aspect of the disclosure relates to DCMF/NCRF node transfer options.

Some differences associated with a device-centric architecture using a local DCMF/NCRF, as opposed to a central one include: core network's central DCMF and NCRF entities are ‘always on’ and ‘always available’; while a local DCMF/local NCRF are on devices that may move (and lose cell coverage) or may be switched off.

Considerations may be needed on how devices searching for compute resources can manage if a local DCMF/local NCRF disappears. For example, embodiments describe how another local device take the L-DCMF/L-NCRF role, and how the new L-DCMF/L-NCRF is initiated.

In some embodiments, the L-DCMF/L-NCRF role change may be device initiated based on one or more the following options.

In a first option, a local device may take over the L-DCMF/L-NCRF role using a cluster head selection within a group of DCMFs/NCRFs. Another device capable of hosting the L-DCMF/L-NCRF can advertise its aim to take over the role. Some cluster head selection concepts that may be used are described as follows.

If the cluster head disappears or becomes unresponsive: a central node (for example, a central DCMF) may assign a new control node as a cluster head (e.g., via the DCA-DCMF protocol); before going out of service, the old cluster head transfers control to a new cluster head, following a handshake with another device or a handshake with the central node; or devices select (or elect) a new cluster head autonomously. The selection of a new cluster head may be based on a general configuration or rule, which may be one or more of the following: pre-programmed into the device; configured by the device owners themselves; configured and allocated by the network; controlled by the network operator; or specified.

Autonomous cluster head node selection/re-selection may take place as follows. Every node takes the parameters that describe its own compute resources and its ability to act as a L-DCMF/L-NCRF and maps it to a “capability ID.” The mechanism is such that no two nodes can have the same capability ID. It can be a hash function. More generally, capability IDs can be sorted in a particular order according to a rule that is configurable (such that higher/lower values are associated with a weight)—for example, higher numbered capability IDs identify a device as eligible to act as a cluster head. Another order is possible as well, based on a rule or starting with the lowest numbered IDs.

In a second option, DCAs are pre-configured with a list of alternate DCMFs, so they know whom to contact in case of a failure. There is the concept of a circuit breaker as a basic means of protection (e.g., a timeout after a failure event). If the currently designated DCMF/NCRF does not respond to a DCA request within a certain (specified) time, the DCA suspends the connection and contacts the secondary node designated as L-DCMF/L-NCRF. There can be a priority list of nodes. The list may be operator controlled or network controlled.

In a third option, for devices that can act as a L-DCMF/L-NCRF, the operator pre-programs devices with respective credentials according to their capabilities and according to “subscription” and/or authorization of certain user groups.

In a fourth option, devices may discover a new DCMF/NCRF in the local group, by starting all over with a discovery message.

In some embodiments, the L-DCMF/L-NCRF role change may be network initiated based on one or more the following options.

In a first option, a next node is pre-defined or designated in the (network allocated) set of DCMFs. The designated next node becomes active upon detection of a failure event. Failover and selection of a new entity is handled by the (central) entity. For example, the NCRF may rely on a ‘keep alive’ message from each of the DCMFs in the set, or may rely on measurements and event notifications. A central entity like a the NCRF, SCP, DCOF, or a network management entity may subscribe to measurements or failure events from DCAs and DCMFs. Upon event notification, the entity may select an appropriate alternative DCMF/NCRF and transfer the control from one node to another. Operator controlled rules can guide/configure this process. A database may be synchronized at specific intervals. The evaluation of failure events can be defined as a rule.

In a second option, the old node (for example, NF on a device) may transfer the L-DCMF/L-NCRF to a neighboring device before going out of service. This may include two operations.

A first operation may be a discovery operation (e.g., a query or broadcast to a neighboring node). The neighboring node may send a positive reply if it is able to host the DCMF/NCRF (for example, if the application is pre-installed or if it can download it from a central repository). Capabilities are another factor to consider. The neighboring node needs to verify that beforehand.

A second operation may be full migration.

Some embodiments describe how, if the old DCMF/NCRF is no longer available, the new DCMF/NCRF gets up-to-date NF configuration, context and state of current compute sessions and respective UE contexts. This may be done in accordance with one or more of the following options.

In a first option, the new DCMF/NCRF accesses a shared database to get the list of clients (DCAs) served by the local DCMF/NCRF, including their contexts or state, if any.

In a second option, state information is replicated to other nodes in the set. In other words the list of clients and their contexts is available at more than one DCMF/NCRF node. If the old DCMF/NCRF breaks down, the new node can retrieve the state from another node. This may be the case, for example, in a set of DCMF/NCRF entities that serve certain types of DCAs/a certain number of DCAs or a geographical region of devices in parallel (load sharing).

Some embodiments describe how to handle the case where multiple devices advertise the aim to assume the role of a local DCMF/NCRF. This may be done in a manner similar to the device-initiated method of selecting new L-DCMF/L-NCRF discussed above.

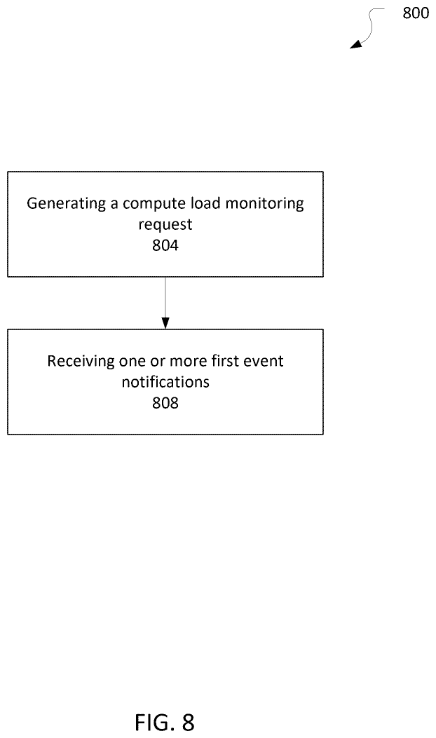

FIG. 8 illustrates an operation flow/algorithmic structure 800 in accordance with some embodiments. The operation flow/algorithmic structure 800 may be performed by, or implemented in, an NF of a core network (for example, a DCEMF) or components therein such as, for example, processor circuitry of 1204.

The operation flow/algorithmic structure 800 may include, at 804, generating a compute load monitoring request. The compute load monitoring request may include a measurement configuration for a KPI event. The compute load monitoring request may be output for transmission to a DCMF.

The operation flow/algorithmic structure 800 may further include, at 808, receiving one or more first event notifications. The received first event notifications may be associated with the KPI event and may be received from the DCMF.

In some embodiments, the operation flow/algorithmic structure 800 may further include detecting a trigger for the KPI event based on the one or more first event notifications. The trigger event may be associated with compute load being greater than a threshold, QoS degradation, or computation response time is greater than a threshold. After detecting the trigger, an indication may be generated for transmission to a DCOF. The indication may indicate that a compute load report is available for the KPI event. The DCOF may then provide the DCEMF/processor circuitry a subscription to the compute load report.

In some embodiments, the operation flow/algorithmic structure 800 may include generating, for transmission to the DCOF, a second event notification based on detecting the trigger and the subscription to the compute load report.

In some embodiments, the operation flow/algorithmic structure 800 may include performing a compute task based on the one or more first event notifications. The compute task may be reporting a KPI, detecting a failure, computing load and quality supervision measurements; detecting event notifications; collecting compute performance data and statistics; or collecting or calculating runtime metrics.

In some embodiments, the operation flow/algorithmic structure 800 may include switching from a first operation mode to a second operation mode. The first operation mode and the second operation mode may be selected from a centralized mode, an edge mode, a local mode, and a distributed mode.

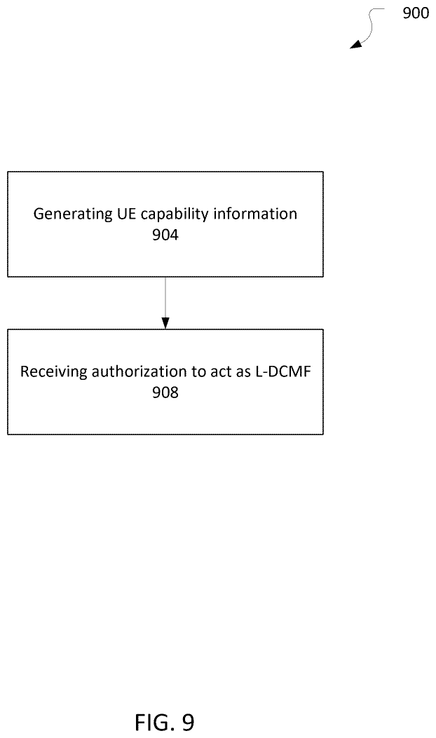

FIG. 9 illustrates an operation flow/algorithmic structure 900 in accordance with some embodiments. The operation flow/algorithmic structure 900 may be performed by, or implemented in, a DCEMF or components therein such as, for example, processor circuitry of 1104.

The operation flow/algorithmic structure 800 may include, at 804, generating UE capability information. The UE capability information may include an indication of support for hosting a L-DCMF. The UE capability information may be output for transmission to a core network.

The operation flow/algorithmic structure 800 may further include, at 808, receiving an authorization to act as the L-DCMF. Upon receiving the authorization, the UE/processor circuitry may perform onboarding operations to act as the L-DCMF. This may include receiving L-DCMF image/code, an initial configuration, and subscriber base. This may additionally/alternatively include registering as the L-DCMF with the central DCMF.

In some embodiments, the operation flow/algorithmic structure 900 may further include switching the L-DCMF from a suspended state to an active state. This may be done after detecting a trigger condition. In some embodiments, after performing the switch, the UE/processor circuitry may generate an indication to be transmitted to the C-NCRF that the L-DCMF is in the active state.

In some embodiments, the UE/processor circuitry may determine one or more DCAs are to be associated with the L-DCMF. The DCAs may be notified of the L-DCMF to use prior to migrating.

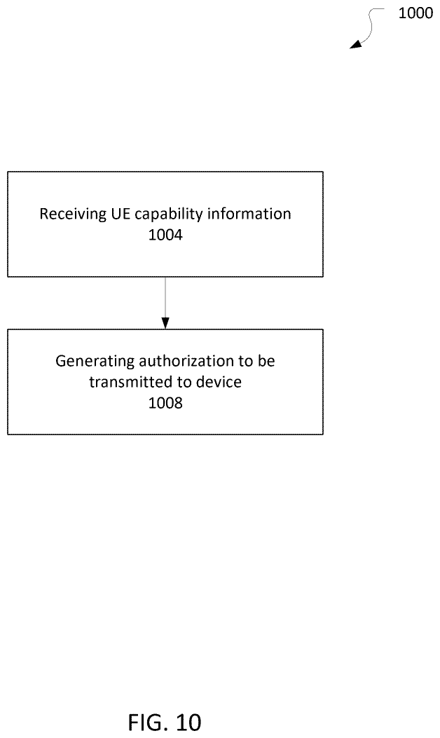

FIG. 10 illustrates an operation flow/algorithmic structure 1000 in accordance with some embodiments. The operation flow/algorithmic structure 1000 may be performed by, or implemented in, a device of a CN/RAN or components therein such as, for example, processor circuitry of 1104.

The operation flow/algorithmic structure 1000 may include, at 1004, receiving UE capability information. The UE capability information may include an indication of support for hosting a L-DCMF.

The operation flow/algorithmic structure 1000 may further include, at 1008, generating an authorization to be transmitted to a device (for example, a UE or powerful device as described herein). The authorization to authorize the device to act as the L-DCMF.

In some embodiments, the operation flow/algorithmic structure 1000 may include performing one or more operations to onboard the L-DCMF. These may include outputting, for transmission to the device, L-DCMF image/code, an initial configuration, and subscriber base.

In some embodiments, the operation flow/algorithmic structure 1000 may include generating, for provision to one or DCAs, access credentials associated with the L-DCMF.

In some embodiments, the operation flow/algorithmic structure 1000 may include performing one or more operations to transition the L-DCMF from a suspended state to an active state. Once active, one or more DCAs may be associated with the L-DCMF. This may be through initial registration or through transference of an existing registration.

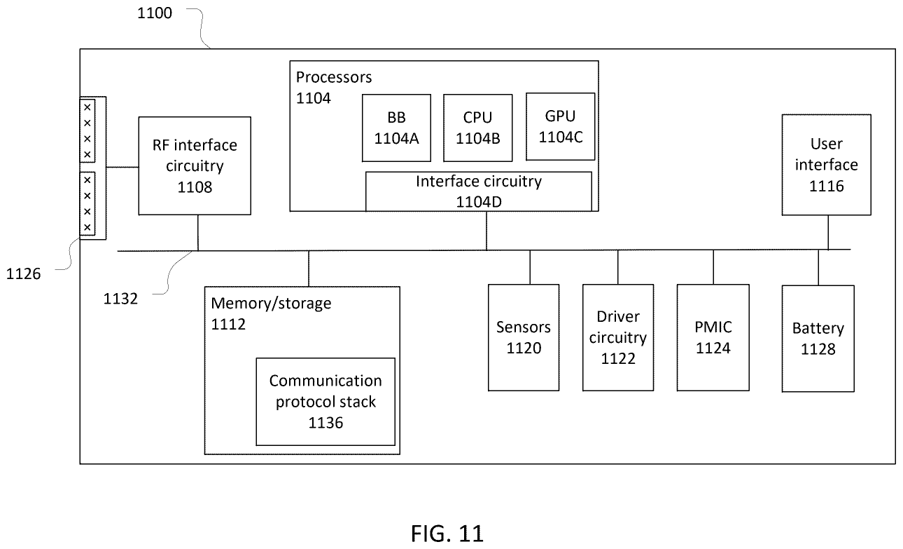

FIG. 11 illustrates a device 1100 in accordance with some embodiments. The device 1100 may be similar to and substantially interchangeable with any device herein.

The device 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The device 1100 may include processors 1104, RF interface circuitry 1108, memory/storage 1112, user interface 1116, sensors 1120, driver circuitry 1122, power management integrated circuit (PMIC) 1124, antenna 1126, and battery 1128. The components of the device 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the device 1100. However, some of the components shown may be omitted, additional components may be present, and different arrangement of the components shown may occur in other implementations.

The components of the device 1100 may be coupled with various other components over one or more interconnects 1132, which may represent any type of interface, input/output, bus (local, system, or expansion), transmission line, trace, or optical connection that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the device 1100 to perform ubiquitous computing operations as described herein. The processors 1104 may also include interface circuitry 1104D to communicatively couple the processor circuitry with one or more other components of the device 1100.

In some embodiments, the baseband processor 1104A may access a communication protocol stack 1136 in the memory/storage 1112 to communicate over a 3GPP compatible network. In general, the baseband processor 1104A may access the communication protocol stack 1136 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1108.

The baseband processor 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the device 1100 to perform ubiquitous computing operations as described herein.

The memory/storage 1112 includes any type of volatile or non-volatile memory that may be distributed throughout the device 1100. In some embodiments, some of the memory/storage 1112 may be located on the processors 1104 themselves (for example, memory/storage 1112 may be part of a chipset that corresponds to the baseband processor 1104A), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and a radio frequency front module (RFEM) that allows the device 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include antenna elements to convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, or phased array antennas. The antenna 1126 may have one or more panels designed for specific frequency bands including bands in FR1 or FR2.

The user interface 1116 includes various input/output (I/O) devices designed to enable user interaction with the device 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the device 1100.

The sensors 1120 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that operate to control particular devices that are embedded in the device 1100, attached to the device 1100, or otherwise communicatively coupled with the device 1100. The driver circuitry 1122 may include individual drivers allowing other components to interact with or control various input/output (I/O) devices that may be present within, or connected to, the device 1100. For example, driver circuitry 1122 may include a display driver to control and allow access to a display device, a touchscreen driver to control and allow access to a touchscreen interface, sensor drivers to obtain sensor readings of sensors 1120 and control and allow access to sensors 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the device 1100. In particular, with respect to the processors 1104, the PMIC 1124 may control power-source selection, voltage scaling, battery charging, or DC-to-DC conversion.

A battery 1128 may power the device 1100, although in some examples the device 1100 may be mounted deployed in a fixed location and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

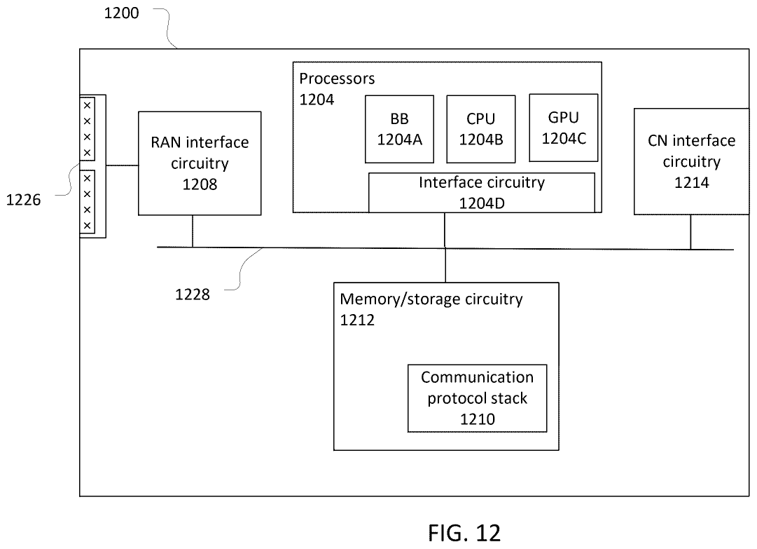

FIG. 12 illustrates a network device 1200 in accordance with some embodiments. The network device 1200 may be similar to, and substantially interchangeable with, the base station 108 or a node implementing an NF such as, for example, a NCRF, DCMF, DCEMF, or DCOF.

The network device 1200 may include processors 1204, RF interface circuitry 1208 (if implemented as a base station), core network (CN) interface circuitry 1214, memory/storage circuitry 1212, and antenna structure 1226.

The components of the network device 1200 may be coupled with various other components over one or more interconnects 1228.

The processors 1204, RF interface circuitry 1208, memory/storage circuitry 1212 (including communication protocol stack 1210), antenna structure 1226, and interconnects 1228 may be similar to like-named elements shown and described with respect to FIG. 9.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage circuitry 1212 to cause the network device 1200 to configure a UE as described herein. The processors 1204 may also include interface circuitry 1204D to communicatively couple the processor circuitry with one or more other components of the network device 1200.

The CN interface circuitry 1214 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1200 via a fiber optic or wireless backhaul. The CN interface circuitry 1214 may include one or more dedicated processors or FPGAs to communicate using one or more of the aforementioned protocols. In some implementations, the CN interface circuitry 1214 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method performed by a DCEMF, the method comprising: generating, for transmission to a DCMF, a compute load monitoring request that includes a measurement configuration for a KPI event; receiving, from the DCMF, one or more first event notifications associated with the KPI event.

Example 2 includes the method of example 1 or some other example herein, further comprising: detecting a trigger for the KPI event based on the one or more first event notifications.

Example 3 includes the method of example 2 or some other example herein, further comprising: generating, for transmission to a DCOF, an indication that a compute load report is to be available for the KPI event; and receiving, from the DCOF, a subscription to the compute load report.

Example 4 includes the method of example 3 or some other example herein, further comprising: generating, for transmission to the DCOF, a second event notification based on detecting the trigger and the subscription to the compute load report.

Example 5 includes the method of example 2 or some other example herein, wherein the trigger event is associated with compute load being greater than a threshold, QoS degradation, or computation response time is greater than a threshold.

Example 6 includes the method of example 1 or some other example herein, wherein the task is a key performance indicator, a failure detection, or a parameter related to KPI or failure detection.

Example 7 includes the method of example 1 or some other example herein, further comprising: switching from a first operation mode to a second operation mode, wherein the first operation mode and the second operation mode are: a centralized mode, an edge mode, a local mode, or a distributed mode.

Example 8 includes a method comprising: generating UE capability information to include an indication of support for hosting a L-DCMF, the UE capability information to be transmitted to a core network; and receiving an authorization to act as the L-DCMF.

Example 9 includes the method of example 8 or some other example herein, further comprising: performing onboarding operations to act as the L-DCMF.

Example 10 includes the method of example 8 or some other example herein, further comprising: registering with a central NCRF.

Example 11 includes the method of example 8 or some other example herein, further comprising: switching the L-DCMF from a suspended state to an active state; and generating an indication to be transmitted to the C-NCRF that the L-DCMF is in the active state.

Example 12 includes the method of example 8 or some other example herein, further comprising: determining one or more DCAs are migrated to be associated with the L-DCMF.

Example 13 includes a method comprising: receiving UE capability information that includes an indication of support for hosting a L-DCMF; and generating an authorization to be transmitted to a device, the authorization to authorize the device to act as the L-DCMF.

Example 14 includes the method of example 13 or some other example herein, further comprising: performing one or more operations to onboard the L-DCMF.

Example 15 includes the method of example 13 or some other example herein, further comprising: generating, for provision to one or DCAs, access credentials associated with the L-DCMF.

Example 16 includes the method of example 13 or some other example herein, further comprising: performing one or more operations to transition the L-DCMF from a suspended state to an active state.

Example 17 includes the method of example 13 or some other example herein, further comprising: associating one or more DCAs with the L-DCMF.

Example 18 includes a method comprising: allocate one or more compute NFs in a network environment, wherein the one ore more compute NFs include DCMFs, NCRFs, etc.; detect one or more events; perform at least one load supervision operation based on the one or more events.

Example 19 includes the method of example 18 or some other example herein, wherein the at least one load supervision operation includes scaling DCMFs up or down.

Example 20 includes the method of example 18 or some other example herein, wherein the method is performed by a distributed computing orchestration function.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
generating, for transmission to a distributed computing management function (DCMF), a compute load monitoring request that includes a measurement configuration for a key performance indicator (KPI) event;
receiving, from the DCMF, one or more first event notifications associated with the KPI event.

2. The method of claim 1, further comprising:
detecting a trigger for the KPI event based on the one or more first event notifications.

3. The method of claim 2, further comprising:
generating, for transmission to a distributed computing orchestration function (DCOF), an indication that a compute load report is to be available for the KPI event.

4. The method of claim 3, further comprising:
receiving, from the DCOF, a subscription to the compute load report.

5. The method of claim 3, further comprising:
generating, for transmission to the DCOF, a second event notification based on detecting the trigger and the subscription to the compute load report.

6. The method of claim 2, wherein the trigger event is associated with compute load being greater than a threshold, a quality of service (QoS) degradation, or a computation response time being greater than a threshold.

7. The method of claim 1, further comprising:
performing a compute task based on the one or more first event notifications.

8. The method of claim 7, wherein the compute task is reporting a KPI, detecting a failure, computing load and quality supervision measurements, detecting event notifications, collecting compute performance data and statistics, or collecting or calculating runtime metrics.

9. The method of claim 1, further comprising:
switching from a first operation mode to a second operation mode, wherein the first operation mode and the second operation mode are: a centralized mode, an edge mode, a local mode, or a distributed mode.

10. A method comprising:
generating UE capability information to include an indication of support for hosting a L-DCMF, the UE capability information to be transmitted to a core network; and
receiving an authorization to act as the L-DCMF.

11. The method of claim 10, further comprising:
performing onboarding operations to act as the L-DCMF.

12. The method of claim 10, further comprising:
registering with a central NCRF.

13. The method of claim 10, further comprising:
switching the L-DCMF from a suspended state to an active state.

14. The method of claim 13, further comprising:
generating an indication to be transmitted to the C-NCRF that the L-DCMF is in the active state.

15. The method of claim 10, further comprising:
determining one or more DCAs are migrated to be associated with the L-DCMF.

16. A method comprising:
receiving UE capability information that includes an indication of support for hosting a L-DCMF; and
generating an authorization to be transmitted to a device, the authorization to authorize the device to act as the L-DCMF.

17. The method of claim 16, further comprising:
performing one or more operations to onboard the L-DCMF.

18. The method of claim 16, further comprising:
generating, for provision to one or DCAs, access credentials associated with the L-DCMF.

19. The method of claim 16, further comprising:
performing one or more operations to transition the L-DCMF from a suspended state to an active state.

20. The method of claim 16, further comprising:
associating one or more DCAs with the L-DCMF.
